(19) United States
(12) Patent Application Publication
(10) Pub. No.: US 2021/0132873 A1
(43) Pub. Date: May 6, 2021

(54) PRINT MANAGEMENT SYSTEM, MANAGEMENT SERVER, AND PRINT MANAGEMENT METHOD

(71) Applicant: SEIKO EPSON CORPORATION, Tokyo (JP)

(72) Inventors: Kohei SHIRATORI, Matsumoto-shi (JP); Motoaki HARA, Suwa-shi (JP); Tomoyuki KURATA, Matsumoto-shi (JP); Hiroyuki KURAMOTO, Shiojiri-shi (JP)

(21) Appl. No.: 17/083,858

(22) Filed: Oct. 29, 2020

(30) Foreign Application Priority Data
Oct. 30, 2019 (JP) 2019-197165

(51) Int. Cl. G06F 3/12; G06Q 20/12

(52) U.S. Cl. CPC G06F 3/126; G06F 3/1207; G06F 3/1288; G06F 3/1231; G06Q 20/1235; G06F 3/1259

(57) ABSTRACT

In a print management system, a terminal device transmits a print request designating a content to be printed, a first server receives the print request, transmits a print instruction including data of the content and an e-mail address designating a printer to a second server, the second server transmits print data to the printer designated by the e-mail address, and transmits, to the first server, print result information indicating a result of the print data printed by the printer, and the first server generates, based on the print result information, billing information indicating a price for a copyright of the content.

The present application is based on, and claims priority from JP Application Serial Number 2019-197165, filed Oct. 30, 2019, the disclosure of which is hereby incorporated by reference herein in its entirety.

### BACKGROUND

### 1. Technical Field

The present disclosure relates to a print management system, a management server, and a print management method.

### 2. Related Art

In the related art, there has been offered a technique of collecting a so-called copyright royalty when a literary work is copied (see, for example, JP-A-2002-7737). JP-A-2002-7737 discloses a configuration including a printer client operated by the user, and a service system that is connected to the printer client and that provides image data of a literary work. According to this configuration, when the user operates the printer client to identify the literary work, the printer client downloads the image data of the literary work and performs printing.

In the configuration described in JP-A-2002-7737, only a printer client connected to a master server that stores image data of literary works, and managed by and installed at a convenience store or a library can be used to copy a literary work. Therefore, there is a problem that the printing apparatus that can be used by the user is limited to a particular device.

### SUMMARY

According to an aspect of the present disclosure, a print management system includes a terminal device that transmits a print request designating a content to be printed, a management server that receives the print request to transmit a print instruction including data of the content designated by the print request, and a print control server that receives the print instruction to transmit print data including data of the content to a printing apparatus, wherein the print request includes designation information designating a printing apparatus that prints the content, wherein the management server transmits the print instruction including the designation information to the print control server, wherein the print control server transmits the print data to the printing apparatus designated by the designation information, acquires a result of the print data printed by the printing apparatus, and transmits print result information indicating the acquired result to the management server, and wherein the management server generates billing information indicating a price for a copyright of the content based on the print result information.

In the print management system, the designation information may be an e-mail address assigned to the printing apparatus.

In the above print management system, the print control server may transmit the print result information including information indicating a print amount of the content printed by the printing apparatus to the management server.

In the above print management system, the terminal device may transmit the print request requesting printing of a document including the content, wherein the management server may transmit the print instruction instructing printing of the document to the print control server, wherein the print control server may transmit the print data including data of the document to the printing apparatus, and may transmit, to the management server, the print result information including information indicating a print amount of the document printed by the printing apparatus, and wherein the management server may generate, based on the print result information, the billing information based on the print amount of the document and the number of the contents included in the document.

In the above print management system, the print control server may be configured to receive, from the printing apparatus, a print completion notification indicating that printing of the print data is completed, and transmits the print result information to the management server when the print completion notification is received from the printing apparatus.

In the above print management system, the management server may transmit information indicating a plurality of the contents that is configured to be designated as contents to be print and information indicating a copyright royalty set for each of the contents, and wherein when receiving a designation of the contents to be printed, the terminal device may display information indicating the copyright royalty set for each of the contents.

According to another aspect of the present disclosure, in a management server connected to a terminal device that transmits a print request requesting printing of a content and a print control server that transmits data to a printing apparatus to cause the printing apparatus to perform printing, the management server acquires, from the print request, designation information designating a printing apparatus that prints the content, transmits, to the print control server, a print instruction including the designation information and data of a content designated by the print request, acquires, from the print control server, a print result by the printing apparatus designated by the designation information, and generates, based on the print result, billing information indicating a price for a copyright of the content.

According to still another aspect of the present disclosure, a print management method includes a terminal device designating a content to be printed, requesting printing of the content, and transmitting a print request including designation information designating a printing apparatus that prints the content, a management server receiving the print request, and transmitting, to a print control server, a print instruction including data of a content designated by the print request and the designation information, the print control server receiving the print instruction, transmitting print data including data of the content to the printing apparatus designated by the designation information, acquiring a result of the print data printed by the printing apparatus, and transmitting print result information indicating the acquired result to the management server, and the management server generating, based on the print result information, billing information indicating a price for a copyright of the content.

### BRIEF DESCRIPTION OF THE DRAWINGS

FIG. 1 is a diagram illustrating an example of a configuration of a print management system.

FIG. 2 is a schematic diagram showing a configuration example of data stored in a first server storage unit.

FIG. 3 is an explanatory diagram showing the function of each device constituting the print management system.

FIG. 4 is a sequence diagram showing the operation of the print management system.

FIG. 5 is a sequence diagram showing the operation of the print management system.

### DESCRIPTION OF EXEMPLARY EMBODIMENTS

### 1. Print Management System Configuration

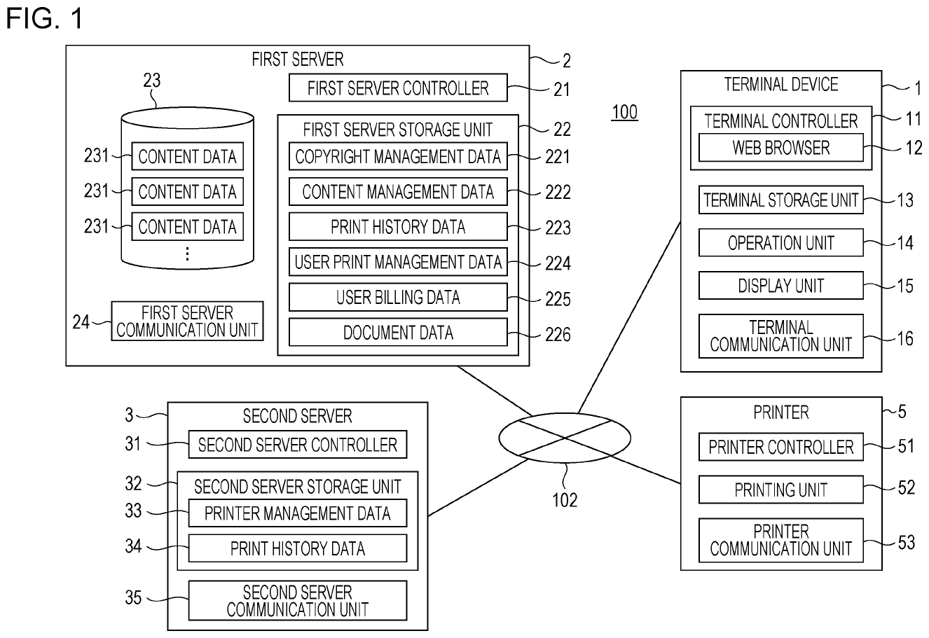

Embodiments to which the present disclosure is applied will be described below with reference to the drawings. FIG. 1 is a diagram illustrating an example of the configuration of a print management system 100. As shown in FIG. 1, the print management system 100 includes a terminal device 1, a first server 2, a second server 3, and a printer 5. The first server 2 corresponds to an example of a management server of the present disclosure, and the second server 3 corresponds to an example of a print control server.

The print management system 100 responds to a user operation to print a content by the printer 5, and calculates a copyright royalty that occurs due to printing of the content to make it possible to perform appropriate billing and collection. In the following description, the content is a literary work whose copyright is owned by the copyright holder. In a narrower sense, the content means a literary work in which the author has the copyright, and copying is permitted in exchange for collection or payment for the price. The specific form of the content may be printable by the printer 5, and is composed of, for example, characters and/or images. In the following description, a literary work that can be transmitted and received in the form of character data and/or image data is exemplified as the content. The price for copyright is known as the copyright royalty. In the present embodiment, an example in which the copyright royalty is collected will be described, but an item listed as billing is not limited as long as it is a price for using the copyright.

The terminal device 1, the first server 2, the second server 3, and the printer 5 are communicably connected to each other via a communication network 102. The communication network 102 is a communication line including a dedicated line, a public line network, a mobile wireless communication network, a local area network (LAN) line, and the like. It may be a wide area network, or may be a local network. Further, the communication network 102 may include various devices such as a circuit switching device and a server. The connection between the communication network 102, and each of the terminal device 1, the first server 2, the second server 3, and the printer 5 may be wireless or wired.

The terminal device 1 is a device used by a user. For example, the terminal device 1 is a desktop computer, a laptop computer, a tablet computer, a smartphone, or the like. The number of the terminal devices 1 and the number of the printers 5 included in the print management system 100 are not limited and may be plural. The terminal device 1 is, for example, a computer or a smartphone personally owned by a user who uses the print management system 100. The printer 5 may be, for example, a printer installed in a store such as a convenience store or a public facility, may be a printer that the user personally owns, or may be a printer installed at the user's office. The number of terminal devices 1 and the number of printers 5 may be the same as or more than the number of users.

The terminal device 1 includes a terminal controller 11, a terminal storage unit 13, an operation unit 14, a display unit 15, and a terminal communication unit 16.

The terminal controller 11 includes a processor such as a central processing unit (CPU) and a microcomputer, and controls the respective units of the terminal device 1 by causing the processor to execute the control program. The terminal controller 11 may include a read only memory (ROM) that stores a program executed by the processor in a nonvolatile manner and/or a random access memory (RAM) that configures a work area of the processor, or other peripheral circuits.

The terminal storage unit 13 is a non-volatile storage device including a magnetic storage device, an optical storage medium, a semiconductor memory device, and the like, and stores programs executed by the processor constituting the terminal controller 11, and various pieces of data. The operation unit 14 is a user interface that receives an operation performed by a user, and output operation data to the terminal controller 11 according to the operation. The operation unit 14 is, for example, an input device such as a mouse or a keyboard. The display unit 15 has a display screen such as a liquid crystal display panel, and displays images and characters on the display screen under the control of the terminal controller 11. The operation unit 14 may be a touch panel that is superimposed on the display screen of the display unit 15 and that detects a touch operation by the user. The terminal communication unit 16 has a communication circuit that executes wired or wireless data communication with the communication network 102. The terminal communication unit 16 transmits and receives data through the communication network 102 under the control of the terminal controller 11.

The terminal controller 11 executes the function of a web browser 12 by executing the programs stored in the terminal storage unit 13. The web browser 12 displays characters and images on the display screen of the display unit 15 based on the display data received by the terminal communication unit 16. Here, the display data contains text data and/or image data, and for example, the data described in a markup language such as a hypertext markup language (HTML).

The first server 2 includes a first server controller 21, a first server storage unit 22, a content data storage unit 23, and a first server communication unit 24. The first server controller 21 includes a processor such as a CPU and a microcomputer, and controls the respective units of the first server 2 by causing the processor to execute the control program. The first server controller 21 may include a ROM that stores a program executed by the processor in a nonvolatile manner, and/or a RAM forming a work area of the processor, or other peripheral circuits.

The first server storage unit 22 is a non-volatile storage device including a magnetic storage device, an optical storage medium, a semiconductor memory device, and the like, and stores programs executed by the processor of the first server controller 21, and various pieces of data. As an example of the data stored in the first server storage unit 22, FIG. 1 shows copyright management data 221, content management data 222, print history data 223, user print management data 224, user billing data 225, and document data 226. Details of each of these pieces of data will be described later.

The content data storage unit 23 is a non-volatile storage device including a magnetic storage device, an optical storage medium, a semiconductor memory device, and the like, and stores content data 231 available to the user. The number and the details of the content data 231 that can be stored in the content data storage unit 23 are not limited. The content data storage unit 23 is, for example, a database that stores the content data 231.

A device different from the first server 2 may include the content data storage unit 23. For example, a third server that stores the content data storage unit 23 may be provided separately from the first server 2. In this case, the third server may be an external server apparatus not included in the print management system 100. An example includes a mode in which a server apparatus operated by a company or an organization that manages the copyright has the content data storage unit 23, and the first server 2 can access this server apparatus to acquire the content data 231 from the content data storage unit 23. Further, the first server 2 may be configured to be able to acquire the content data 231 from the plurality of content data storage units 23. When there is a plurality of server apparatuses operated by a company or an organization that manages the copyright, the first server 2 may be configured to acquire the content data 231 from each of the plurality of server apparatuses.

The first server communication unit 24 has a communication circuit that executes wired or wireless data communication with the communication network 102. The first server communication unit 24 transmits and receives data via the communication network 102 under the control of the first server controller 21.

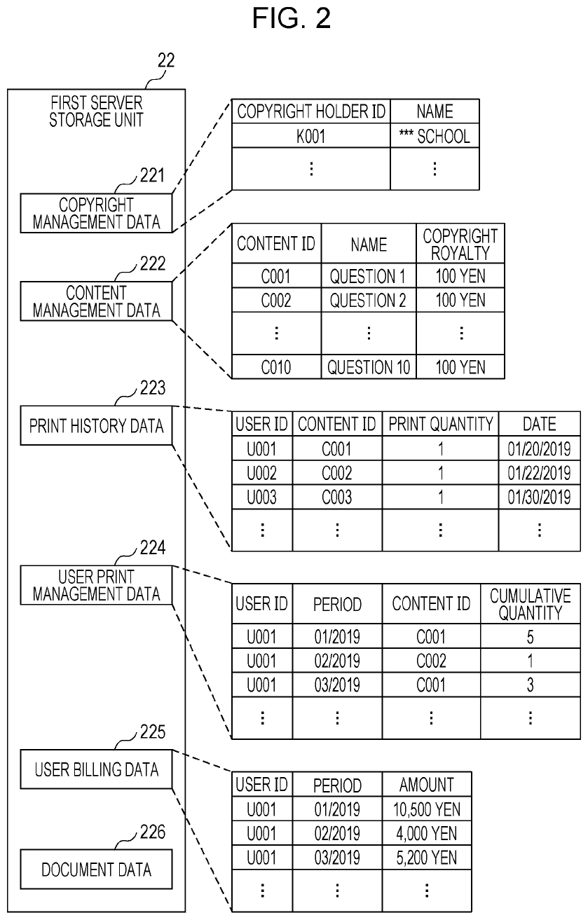

FIG. 2 is a schematic diagram showing a configuration example of data stored in the first server storage unit 22. The copyright management data 221 includes information about the copyright holder who owns the copyright of the content data 231. In the example of FIG. 2, the copyright management data 221 is data in a table format including the names of individuals or corporations who are copyright holders and the copyright holder IDs that are information that can identify and distinguish the copyright holders. The copyright holder indicated by the information of the copyright management data 221 is the copyright holder registered in the print management system 100 as the payee of the copyright royalty of the content data 231.

The content management data 222 includes information for managing the copyright royalty of the content data 231 used in the print management system 100. In the example of FIG. 2, the content management data 222 is data in a table format including a content ID of the content data 231, a name of the content data 231, and a copyright royalty of the content data 231 in association with each other. The content ID is identification information that identifies each piece of the content data 231, and is given to the content data 231 in advance. The copyright royalty included in the content management data 222 is, for example, an amount of money corresponding to one time copy of one piece of the content data 231. In other words, it is the unit price at which the user is charged for one time printing of the content data 231. For example, when a document including a plurality of pieces of the content data 231 is printed once as described later, a copyright royalty equivalent to one time copy for each piece of the content data 231 included in the document is paid.

The print history data 223 includes information about the history of how the user used the content data 231. In the example of FIG. 2, the print history data 223 is data in a table format including a user ID, a content ID, a quantity by which the printer 5 has performed printing, and a date in association with each other. The user ID is identification information given to each user who uses the print management system 100. The quantity of printing is the number of times one piece of the content data 231 identified by the content ID has been printed by the printer 5. Here, the number of times the content data 231 is used, that is, the number of times printing is performed, is a number obtained by multiplying the number of printed print media by the number of contents disposed on each print medium. For example, when one page document in which two pieces of the content data 231 are disposed on one page is printed, the number of times the content data 231 is printed is two. The date of the print history data 223 is a date when the printer 5 performs printing. In the example of FIG. 2, the print history data 223 is a record that differs for each content ID. Therefore, when the printer 5 prints one printed matter including a plurality of pieces of the content data 231, a record of the print history data 223 is generated for each content data 231.

The user print management data 224 includes information in which the number of times the content is used is totaled for each user, each set period, and each content ID. In the example of FIG. 2, the user print management data 224 is data in a table format including a user ID, a period, a content ID, and a cumulative quantity of the content used in association with each other. The cumulative quantity is the total number of times the printer 5 has printed one piece of the content data 231 in the set period.

The user billing data 225 includes information about the copyright royalty collected for each user. In the example of FIG. 2, the user billing data 225 is data in a table format including the amount of the copyright royalty in the set period in association with the user ID. The user billing data 225 corresponds to an example of billing information.

The document data 226 is data of a document including the content data 231. In the document, one or a plurality of pieces of the content data 231 is disposed at a position designated by the terminal device 1. In the print management system 100 of this embodiment, when the user operates the terminal device 1 to create a document, the document data 226 of the created document is not transmitted to the terminal device 1, but is stored in the first server storage unit 22 by the first server 2. Display data for displaying the state of the document data 226 on the display unit 15 is transmitted to the terminal device 1. As a result, it is possible to prevent copying of the content data 231 in a mode in which the copyright royalty cannot be collected.

Returning to FIG. 1, the second server 3 includes a second server controller 31, a second server storage unit 32, and a second server communication unit 35. The second server controller 31 includes a processor such as a CPU and a microcomputer, and controls the respective units of the second server 3 by causing the processor to execute the control program. The second server controller 31 may include a ROM that stores a program executed by the processor in a non-volatile manner, and/or a RAM forming a work area of the processor may be provided, or other peripheral circuits.

The second server storage unit 32 is a non-volatile storage device including a magnetic storage device, an optical storage medium, a semiconductor memory device, and the like, and stores programs executed by the processor of the second server controller 31, and various pieces of data. FIG. 1 shows printer management data 33 and print history data 34 as examples of data stored in the second server storage unit 32.

The printer management data 33 includes information for the second server 3 to identify the printer 5. An individual e-mail address is assigned to the printer 5 used in the print management system 100. The e-mail address will be referred to as an e-mail address in the following description. The e-mail address functions as identification information for identifying respective printers 5, when, for example, the user operates the terminal device 1, and designates the e-mail address of the particular printer 5, the second server 3 identifies the particular printer 5 by the e-mail address. The printer management data 33 includes the e-mail address of the printer 5. Further, for example, the printer management data 33 may include the e-mail address and information for identifying the printer 5 in the communication network 102 in association with each other. An example of this information includes a network address such as an IP address.

The print history data 34 includes information indicating the history of printing performed by the printer 5 based on the data transmitted from the second server 3 to the printer 5. For example, the print history data 34 is configured as data in a table format. In this example, the print history data 34 includes the e-mail address of the printer 5 that has performed printing, the content ID of the content data 231 included in the document printed by the printer 5, and the user ID of the user who has requested printing in association with each other. The print history data 34 may include information indicating that the printer 5 has completed printing. For example, the print history data 34 may include information indicating whether the printing by the printer 5 is normally completed or not completed due to an error or the like.

The second server communication unit 35 has a communication circuit that executes wired or wireless data communication with the communication network 102. The second server communication unit 35 transmits and receives data via the communication network 102 under the control of the second server controller 31.

The printer 5 includes a printer controller 51, a printing unit 52, and a printer communication unit 53. The printer controller 51 includes a processor such as a CPU and a microcomputer, and controls the respective units of the printer 5 by causing the processor to execute the control program. The processor constituting the printer controller 51 may be an integrated device including a ROM, a RAM, other peripheral circuits, and the like. The printer controller 51 controls the printing unit 52 according to the data transmitted by the second server 3, and causes the printing unit 52 to perform printing on the print medium. The printer controller 51 generates status information to transmit the generated status information to the second server 3 when printing by the printing unit 52 is completed or when a printing error occurs.

The printer 5 is a printing apparatus that forms an image on a print medium such as a papersheet or a synthetic resin sheet, and is, for example, an ink jet printer. The printing unit 52 includes, for example, an ink tank, a print head that ejects ink, a transport motor that transports a print medium, and the like. The printer 5 is not limited to an ink jet printer, but may be a dot impact printer or a laser printer. It may be a multifunction machine having the function of the printer, the function of a scanner, and another function, and has no restrictions on the print medium. The printer communication unit 53 has a communication circuit that executes wired or wireless data communication with the communication network 102. The printer communication unit 53 transmits and receives data via the communication network 102 under the control of the printer controller 51.

### 2. Print Management System Function

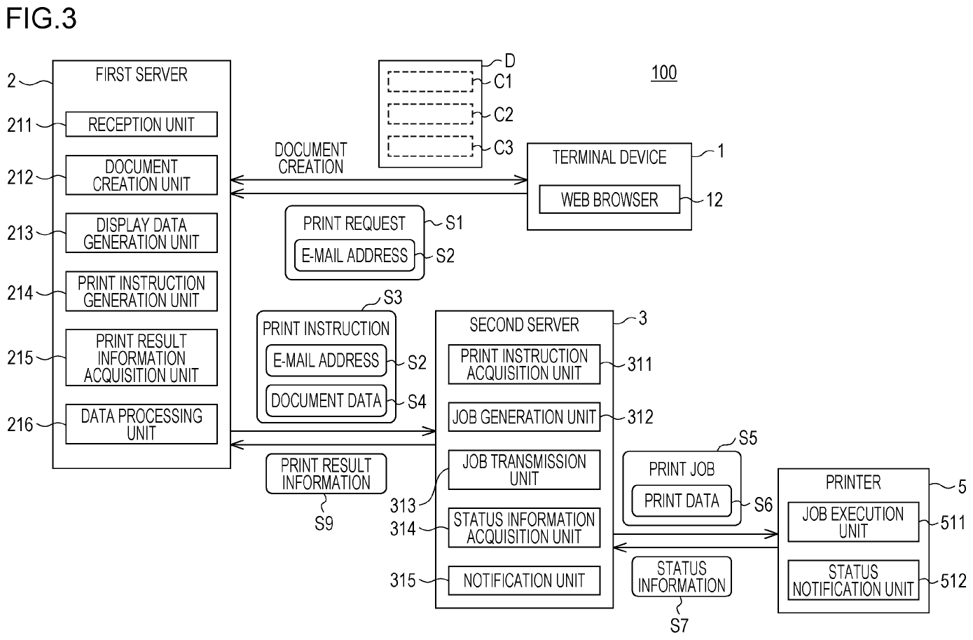

FIG. 3 is an explanatory diagram showing the function of each device constituting the print management system 100. When the user operates the terminal device 1 to access the first server 2, a document D is created based on the information transmitted/received between the terminal device 1 and the first server 2. In the present embodiment, the document D is the data of a document composed of pages of a predetermined size such as A4 size, and is composed of one or more pages. A plurality of contents can be disposed in the document D. In the example of FIG. 3, three contents C1, C2, and C3 are disposed on one page. Since the document D shown in FIG. 3 includes the contents C1, C2, and C3, it is necessary to pay the copyright royalty for single use for each content C1, C2, and C3 each time the one document D is printed. The copyright royalty for each content is defined by the content management data 222.

An example of the document D includes data of a question sheet used in a paper test in a school or a cram school. In this case, the document D includes one or more questions, and the one question is composed of one piece of the content data 231. The user is, for example, a teacher at a school or an instructor at a cram school, and can use the print management system 100 to create a question sheet for a paper test.

The first server controller 21 functions as a reception unit 211, a document creation unit 212, a display data generation unit 213, a print instruction generation unit 214, a print result information acquisition unit 215, and a data processing unit 216. The reception unit 211 receives various requests and various pieces of data transmitted from the terminal device 1.

The document creation unit 212 creates the document data 226 based on the request received by the reception unit 211. The document creation unit 212 stores the document data 226 in the first server storage unit 22. Further, the document creation unit 212 transmits various pieces of information to the terminal device 1 in the process of creating the document D.

The display data generation unit 213 generates display data for the terminal device 1 to display the details of the document data 226. The display data may be any data that can be displayed by the web browser 12, and, for example, HTML data including characters and/or images, or the image data in which the entire page of the document D is imaged. In addition, in stead of the web browser 12, the terminal device 1 may use any application program that displays data on the display unit 15, and, for example, can use various viewer applications that display image data and document data.

As described above, the terminal device 1 receives the display data generated by the display data generation unit 213, but does not acquire the document data 226. For example, the display data generation unit 213 may be configured to generate display data with a lower quality than that the document data 226. In this case, it is possible to effectively suppress the use of the content in a mode in which the copyright royalty cannot be collected. The suppression is more effective when the data generated by the display data generation unit 213 has a low quality to the extent that the visibility of characters and images is impaired when printed by the printer 5. The data quality means, for example, image resolution, number of pixels, font shape, font data format, and the like.

When the reception unit 211 receives a print request S1 from the terminal device 1, the print instruction generation unit 214 generates a print instruction S3 based on the print request S1. The print request S1 is information generated by the terminal device 1 according to a user operation, and includes an e-mail address S2 of the printer 5 that performs printing. For example, the user designates the e-mail address of the printer 5 installed near the user, and the designated e-mail address S2 is included in the print request S1 and transmitted from the terminal device 1 to the first server 2. The e-mail address S2 corresponds to an example of designation information. Other examples of the designation information may include a network address of the printer 5, a telephone number associated with the printer 5, an ID by which the printer 5 can be individually identifies, and the like.

The print instruction generation unit 214 generates the print instruction S3 including the e-mail address S2 and document data S4. The document data S4 is the document data 226 designated by the terminal device 1 among the document data 226 stored in the first server storage unit 22. When the terminal device 1 transmits the print request S1 immediately after the process of creating the document D, the print instruction generation unit 214 regards the document data 226 corresponding to the document D created immediately before as the document data S4.

The second server controller 31 functions as a print instruction acquisition unit 311, a job generation unit 312, a job transmission unit 313, a status information acquisition unit 314, and a notification unit 315. The printer controller 51 functions as a job execution unit 511 and a status notification unit 512.

The print instruction acquisition unit 311 acquires the print instruction S3 transmitted by the first server 2. The job generation unit 312 converts the document data S4 included in the print instruction S3 acquired by the print instruction acquisition unit 311 to generate print data S6 composed of text and/or image data to be printed. Further, the job generation unit 312 generates a print job S5 including the print data S6. The print job S5 is data that instructs the printer 5 to perform printing.

The job transmission unit 313 transmits the print job S5 to the printer 5 designated by the e-mail address S2.

The job execution unit 511 receives the print job S5, and performs printing by the printing unit 52 according to the print data S6 included in the print job S5. The status notification unit 512 generates status information S7 indicating the operating status of the printer 5 to transmit the generated status information S7 to the second server 3.

The timing at which the status notification unit 512 generates the status information S7 is, for example, the timing when an event occurs in the printer 5, the preset timing, and the timing when an inquiry about the operating status is received from the second server 3. The event of the printer 5 is, for example, power-on of the printer 5, completion of printing by the printing unit 52, occurrence of an error in the printing unit 52, occurrence of an error in another part of the printer 5, and the like. When the above event occurs, the status notification unit 512 generates status information S7 indicating the details of the event that has occurred to transmit the generated status information S7 to the second server 3.

In the present embodiment, at least when the printing unit 52 completes printing of the print data S6, the status information S7 is generated. In this case, the status information S7 corresponds to an example of the print completion notification. The status information S7 generated when printing of the print data S6 is completed includes information indicating that the printing is completed and information indicating the print amount. The print amount is information indicating the print amount of the document D, and indicates, for example, the number of print media on which printing is performed based on the print data S6. When the print job S5 gives an instruction to print one piece of the print data S6 a plurality of times, the print amount may be the total number of print media, or may include both the number of times one piece of print data S6 is printed and the total number of print media. The status information S7 includes the print amount of each print data S6 corresponding to one document D.

The status information acquisition unit 314 receives and acquires the status information S7 transmitted by the printer 5. When the status information S7 includes the information indicating that printing of the print data S6 is completed, the notification unit 315 generates print result information S9 indicating the completion of printing to transmit the generated print result information S9 to the first server 2. The status information acquisition unit 314 generates the print result information S9 including the print amount based on the print amount included in the status information S7. As in the status information S7, the print amount included in the print result information S9 is the print amount of the document. The status information acquisition unit 314 may generate the print result information S9 indicating a print failure when the status information S7 includes the information indicating the print failure.

The print result information acquisition unit 215 acquires the print result information S9. When the print result information S9 indicates that printing of the document D by the printer 5 is completed, the data processing unit 216 updates the print history data 223 based on the print amount included in the print result information S9. Further, the data processing unit 216 generates or updates the user print management data 224 based on the print history data 223 in the set period. The data processing unit 216 generates the user billing data 225 based on the user print management data 224.

The copyright royalty collected from the user in the print management system 100 may vary according to the preset condition. In this case, the data processing unit 216 updates the user billing data 225 in consideration of the condition of the variation in the copyright royalty.

For example, it is conceivable that a variation in the copyright royalty is set for the content data 231 based on the number of times of or the frequency of copying. As an example, when the number of times copying is performed is equal to or more than a designated threshold value within a set period, the copyright royalty per time is reduced. Further, as an example, an upper limit of the copyright royalty within the set period is set and the copyright royalty exceeding the upper limit is not collected. Further, as an example, the copyright royalty per time is increased when the number of times copying is performed is equal to or more than a designated threshold value within a set period. The variation in the copyright royalty and the condition of the variation in the copyright royalty are set in association with the content ID. The content management data 222 may include data indicating the variation in copyright royalty and the condition thereof.

After updating the user print management data 224, the data processing unit 216 refers to the print history data 223 and determines whether the condition of the variation in the copyright royalty is met. When the condition of the variation in the copyright royalty is satisfied, the data processing unit 216 calculates a charge considering the set variation for each user ID and updates the user billing data 225.

### 3. Operations of Terminal Device and First Server

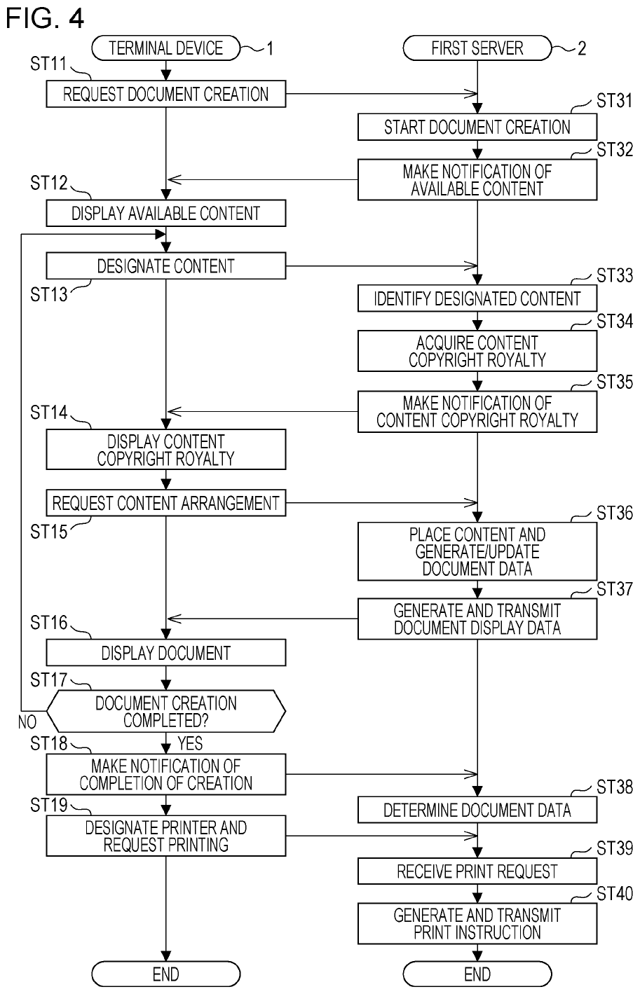

FIG. 4 is a sequence diagram showing the operation of the print management system 100, showing the operations of the terminal device 1 and the first server 2. The sequence shown in FIG. 4 corresponds to the process of generating the document data 226 in the print management system 100.

The operation of the terminal device 1 of FIG. 4 is performed by the terminal controller 11. In the operation of the first server 2 shown in FIG. 4, steps ST31 to ST36 and ST38 correspond to the operations of the reception unit 211 and the document creation unit 212, and step ST37 corresponds to the operation of the display data generation unit 213. Step ST39 corresponds to the operation of the reception unit 211, and step ST40 corresponds to the operation of the print instruction generation unit 214.

The terminal device 1 requests the first server 2 to create the document D according to the operation of the user (step ST11). The first server 2 starts to create the document D in accordance with the request from the terminal device 1 (step ST31). The first server 2 notifies the terminal device 1 of the content to be printed that is available (step ST32). In step ST32, the first server 2 transmits the content data 231 that can be used by the terminal device 1 in the print management system 100, or the data related to the content corresponding to the content data 231. This data is, for example, display data for displaying one or a plurality of available contents in a format of list on the display unit 15. Further, the above data is display data for displaying the available contents side by side on the display unit 15. In step ST32, the first server 2 may transmit, to the terminal device 1, the data of the template of the document D in which the content is disposed, together with the above data.

The terminal device 1 displays the content that can be used to create the document D based on the information transmitted from the first server 2 (step ST12). Here, the user operates the terminal device 1 to designate the content to be disposed in the document D. The terminal device 1 transmits information indicating the content designated by the user's operation to the first server 2 (step ST13).

The first server 2 identifies the content data 231 and the content ID corresponding to the content designated by the terminal device 1 (step ST33). The first server 2 acquires the copyright royalty of the identified content from the content management data 222 (step ST34) and notifies the terminal device 1 of the acquired copyright royalty (step ST35).

The terminal device 1 displays the copyright royalty notified from the first server 2 on the display unit 15 (step ST14). As a result, since the user can be aware of the copyright royalty when using the content designated in step ST13 before creating the document D, it is possible to save the trouble of creating the document D, and use the content within a predetermined budget.

When the user wants to stop using the content designated in step ST13 by looking at the copyright royalty displayed in step ST14, the terminal device 1 may return the process from step ST14 to step ST13 based on an operation of the user.

The terminal device 1 requests the arrangement of the content in the document D according to the user's operation (step ST15). In step ST15, the information designating the position and the size of the content in the document D is transmitted from the terminal device 1.

The first server 2 acquires the information transmitted in step ST15, arranges the content, and generates the document D. Then, the first server 2 generates the document data 226 of the generated document D and stores the generated document data 226 in the first server storage unit 22 (step ST36). When the document data 226 has already been created in step ST36, the first server 2 updates the document data 226.

The first server 2 generates, based on the updated document data 226, display data for displaying the printed state of the document D by the web browser 12 to transmit the generated updated document data 226 to the terminal device 1 (step ST37).

The terminal device 1 displays the details of the document D on the display unit 15 by the function of the web browser 12 based on the display data transmitted from the first server 2 (step ST16). As a result, the user can create the document D while visually checking the state of the document D.

Here, the terminal device 1 determines whether the creation of the document D is completed (step ST17). In step ST17, a determination is made based on whether the user has input to instruct the completion of the creation. When the creation is not completed (step ST17; NO), the terminal device 1 returns the process to step ST13. When the creation is completed (step ST17; YES), the terminal device 1 notifies the first server 2 of the creation completion (step ST18).

When notified by the terminal device 1 that the creation of the document D is completed, the first server 2 determines the document data 226 as the document to be printed (step ST38). Further, the terminal device 1 designates the printer 5 that performs printing to request printing in accordance with the user's operation (step ST19). In step ST39, the information designating the document D to be printed and the print request S1 including the e-mail address S2 of the printer 5 are transmitted from the terminal device 1 to the first server 2.

The first server 2 receives the print request S1 (step ST39), generates the print instruction S3 including the e-mail address S2 included in the print request S1 and the document data S4 designated by the print request S1, and transmits the generated print instruction S3 to the second server 3 (step ST40).

In this way, the user can operate the terminal device 1 to create the document D using the content data 231 and instruct printing. Further, the user can designate the printer 5 that performs printing. Then, in the process of creating the document D, the content data 231 and the document data 226 that is the data of the document D are not transmitted to the terminal device 1. Therefore, it is possible to prevent the content data 231 from being used in a mode in which the copyright royalty cannot be collected.

### 4. Operations of First Server, Second Server and Printer

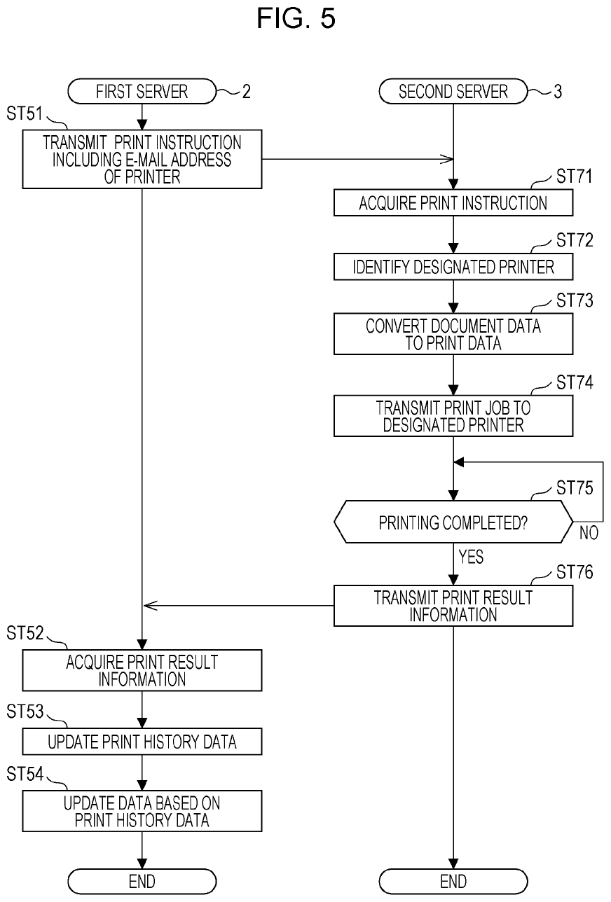

FIG. 5 is a sequence diagram showing the operation of the print management system 100, showing the operations of the first server 2 and the second server 3. The sequence illustrated in FIG. 5 corresponds to the process of causing the printer 5 to perform printing based on the document data 226 in the print management system 100.

In the operation of the first server 2 shown in FIG. 5, step ST51 corresponds to the operation of the print instruction generation unit 214, step ST52 corresponds to the operation of the print result information acquisition unit 215, and steps ST53 to ST54 correspond to the operation of the data processing unit 216. In the operation of the second server 3 shown in FIG. 5, step ST71 corresponds to the operation of the print instruction acquisition unit 311, and steps ST72 to ST73 correspond to the operation of the job generation unit 312. Step ST74 corresponds to the operation of the job transmission unit 313, and step ST75 corresponds to the operation of the status information acquisition unit 314. Step ST76 corresponds to the operation of the notification unit 315.

The first server 2 generates the print instruction S3 based on the print request S1 transmitted by the terminal device 1 to transmit the generated print instruction S3 to the second server 3 (step ST51). As described above, the print instruction S3 includes the e-mail address S2 designated by the terminal device 1.

The second server 3 acquires the print instruction S3 (step ST71), refers to the printer management data 33 based on the e-mail address S2, and identifies the designated printer 5 (step ST72). The second server 3 extracts the document data S4 from the print instruction S3 and converts the extracted document data S4 into print data S6 (step ST73). The second server 3 generates the print job S5 including the print data S6 to transmit the generated print job S5 to the printer 5 (step ST74).

Although not shown in FIG. 5, the printer 5 receives the print job S5 transmitted by the second server 3 and prints the print data S6. The printer 5 transmits the status information S7 to the second server 3 when printing of the print data S6 is completed or the like.

After transmitting the print job S5, the second server 3 determines whether printing by the printer 5 is completed (step ST75). In step ST75, the second server 3 stands by while not receiving, from the printer 5, the status information S7 indicating the completion of printing (step ST75; NO). When receiving the status information S7 indicating the completion of printing from the printer 5, the second server 3 makes an affirmative determination (step ST75; YES), and transmits the print result information S9 to the first server 2 (step ST76).

The first server 2 receives and acquires the print result information S9 from the second server 3 (step ST52), and updates the print history data 223 based on the print amount included in the print result information S9 (step ST53). In step ST53, the first server 2 calculates the print amount for each content ID based on the print amount of the document included in the print result information S9 and the content ID of the content included in the document data 226. The first server 2 adds the calculated information to the print history data 223. The first server 2 totals the updated print history data 223 to update the user print management data 224 and the user billing data 225 (step ST54).

### 5. Effects of Embodiment

As described above, the print management system 100 according to the embodiment to which the present disclosure is applied includes the terminal device 1 that transmits the print request S1 designating the content to be printed. The print management system 100 includes the first server 2 that receives the print request S1 and that transmits a print instruction including data of the content designated by the print request S1, and the second server 3 that receive the print instruction and that transmits the print data S6 including the content data to the printer 5. The print request S1 includes the e-mail address S2 that designates the printer 5 that prints the content. The first server 2 transmits the print instruction including the e-mail address S2 to the second server 3. The second server 3 transmits the print data S6 to the printer 5 designated by the e-mail address S2, acquires the status information S7 indicating the result of the print data S6 printed by the printer 5, and transmits, to the first server 2, the print result information S9 indicating the acquired result. The first server 2 generates the user billing data 225 indicating the price for the copyright of the content based on the print result information S9. The number of contents designated by the print request S1 may be one or plural.

Further, the first server 2 as the management server of the present disclosure includes the terminal device 1 that transmits the print request s1 requesting printing of the content, and a server connected to the second server 3 that transmits data to the printer 5 to cause the printer 5 to perform printing. From the print request S1, the first server 2 acquires the e-mail address S2 that designates the printer 5 that prints the content, and transmits, to the second server 3, a print instruction including the e-mail address S2 and the data of the content designated by the print request S1. The first server 2 acquires, from the second server 3, a print result by the printer 5 designated by the e-mail address S2, and generates the user billing data 225 indicating a price for the copyright of the content based on the print result.

According to the print management system 100 to which the present disclosure is applied, and the first server 2 constituting the print management system 100, it is possible to print the content, which is a literary work by the printer 5 designated by the terminal device 1. Therefore, the literary work can be printed by various printers 5, and the convenience of the user can be improved. Furthermore, it is possible to accurately manage the price for the copyright set for the literary work based on the information output by the printer 5. Therefore, it is possible to properly collect the price for the copyright by using the user billing data 225. Further, in the print management system 100, since the content data is transmitted from the first server 2 to the second server 3 as the print instruction S3, it is not necessary to transmit the content to the terminal device 1. Therefore, it is possible to prevent or suppress the use of the content in a mode in which the price cannot be managed.

In the print management method in the print management system 100, the terminal device 1 designates one or a plurality of contents to be printed, requests printing of content, and transmits the print request S1 including an e-mail address S2 designating the printer 5 that prints the content. The first server 2 receives the print request S1, and transmits, to the second server 3, a print instruction including the data of the content designated by the print request S1 and the e-mail address S2. The second server 3 receives the print instruction, and transmits the print data S6 including the content data to the printer 5 designated by the e-mail address S2. The second server 3 acquires the result of the print data S6 printed by the printer 5 to transmit, to the first server 2, the print result information S9 indicating the acquired result. The first server 2 generates the user billing data 225 indicating the price for the copyright of the content based on the print result information S9. According to the print management method performed by the print management system 100, the literary work can be printed by various printers 5, and the convenience of the user can be improved. Further, it is possible to properly collect the price for the copyright by using the user billing data 225. In addition, it is possible to prevent or suppress the use of the content in a mode in which the price cannot be managed.

In the print management system 100, the designation information designating the printer 5 is the e-mail address S2 assigned to the printer 5. Therefore, the user who operates the terminal device 1 can easily identify and designate the printer 5.

The second server 3 transmits, to the first server 2, the print result information S9 including the information indicating the print amount of the content printed by the printer 5. As a result, the price for the copyright can be accurately calculated based on the actual usage amount of the content.

The terminal device transmits the print request S1 requesting printing of a document including the content, and the first server 2 transmits the print instruction S3 instructing printing of the document to the second server 3. The second server 3 transmits the print data S6 including document data to the printer 5. The second server 3 transmits, to the first server 2, the print result information S9 including the information indicating the print amount of the document by the printer 5. Based on the print result information S9, the first server 2 generates and updates the user billing data 225 based on the print amount of the document and the number of contents included in the document. As a result, the first server 2 causes the printer 5 to perform printing with the document including the content as a unit, and calculates the copyright royalty for the content based on the print amount of the document. Therefore, the print amount can be easily managed without providing the printer 5 with a function of identifying the content, and the copyright royalty for each content can be accurately obtained.

The second server 3 can receive, from the printer 5, the status information S7 indicating that printing of the print data S6 is completed, and transmits the print result information S9 to the first server 2 when the status information S7 is received from the printer 5. As a result, the price for the copyright can be calculated more accurately in consideration of the result of the content printed by the printer 5.

The first server 2 transmits information indicating a plurality of contents that can be designated as contents to be print and information indicating the copyright royalty set for each content. When receiving the designation of the content to be printed, the terminal device 1 displays the information indicating the copyright royalty set in the content. For this reason, since the user operating the terminal device 1 can select the desired content based on the available content and the copyright royalty for each content, it is possible to improve the convenience of using the content.

### 6. Other Embodiments

The present disclosure is not limited to the configuration of the above-described embodiment, and can be implemented in various modes without departing from the scope of the disclosure.

The print management system 100 described in the above embodiment has a configuration in which the first server 2 generates and updates the user billing data 225, but the terminal device 1 may be charged based on the user billing data 225. Alternatively, the first server 2 may access a server provided by a financial institution, a fund settlement operator, or a fund transfer operator to perform settlement based on the user billing data 225.

Also, for example, the specific mode of communication between the second server 3 and the printer 5 is not limited, and the print job S5 and the status information S7 may be transmitted and received in accordance with, for example, a general-purpose protocol such as a UDP, or a TCP/IP, or a particular protocol. Further, the second server 3 and the printer 5 may transmit and receive the print job S5 and the status information S7 by an e-mail. That is, the second server 3 generates the print job S5 in an e-mail format including the print data S6 as an attachment file, and transmits the generated print job S5 to the printer 5 according to the e-mail transmission protocol with the e-mail address S2 as the destination. In this case, the printer management data 33 stored in the second server 3 may not include the network address of the printer 5 or the like. The e-mail address of the second server 3 as a transmission source is assigned to the e-mail of the print job S5. Therefore, the printer 5 may transmit the status information S7 as an e-mail to the second server 3 according to the e-mail transmission protocol. In this case, the second server 3 acquires the status information S7 by receiving the e-mail transmitted by the printer 5.

Further, for example, each of the first server 2 and the second server 3 shown in the above embodiment is not limited to the example of the configuration of a single server apparatus. It may be composed of a plurality of server apparatuses, or may be composed of a cloud server. Further, the first server 2 and the second server 3 may be configured as the same server apparatus.

In addition, the sequences shown in FIGS. 4 and 5, shows the operation of printing the documents D one by one based on the print request S1 transmitted by the terminal device 1, but for example, a plurality of documents D may be collectively printed by the printer 5. In this case, the print request S1 transmitted by the terminal device 1 may instruct printing of the plurality of documents D. Further, the first server 2 may store a plurality of print requests S1 transmitted by the terminal device 1 and perform the process on them collectively, or the second server 3 may store the print instruction S3.

Further, at least part of respective functional block shown in FIGS. 1, 2, and 3 may be implemented by hardware, or may be implemented by cooperation of hardware and software. Further, the control program executed by the first server controller 21 may be stored in the HDD. Further, the control program stored in the external device may be acquired and executed via the first server communication unit 24 or the like.

The process units in the sequence diagrams shown in FIGS. 4 and 5 are divided according to the main processing content in order to facilitate understanding of the operation of each unit of the print management system 100. The embodiments are not limited by the division method or the name of these process units, and the operations of respective units of the print management system 100 can be divided into more process units and can be divided so that one process unit includes many more processes. Further, the processing order shown in the sequence diagrams of FIGS. 4 and 5 is an example, and the order of part of the processing can be exchanged.

Further, the processing method performed by the first server controller 21 can be implemented by causing a processor constituting the first server controller 21 to execute control programs, and the same applies to the second server controller 31. The control programs can also be recorded on a recording medium recorded so as to be readable by a computer. As the recording medium, a magnetic or optical recording medium or a semiconductor memory device can be used. Specifically, examples of the recording medium include a portable recording medium such as a flexible disk, a compact disk read only memory (CD-ROM), a digital versatile disc (DVD), a Blu-ray (registered trademark) disc, a magneto-optical disk, a flash memory, or a card type recording medium, and a fixed type medium.

What is claimed is:

1. A print management system comprising:
a terminal device that transmits a print request designating a content to be printed;
a management server that receives the print request to transmit a print instruction including data of the content designated by the print request; and
a print control server that receives the print instruction to transmit print data including data of the content to a printing apparatus, wherein
the print request includes designation information designating a printing apparatus that prints the content, wherein
the management server transmits the print instruction including the designation information to the print control server, wherein
the print control server transmits the print data to the printing apparatus designated by the designation information, acquires a result of the print data printed by the printing apparatus, and transmits print result information indicating the acquired result to the management server, and wherein
the management server generates billing information indicating a price for a copyright of the content based on the print result information.

2. The print management system according to claim 1, wherein the designation information is an e-mail address assigned to the printing apparatus.

3. The print management system according to claim 1, wherein the print control server transmits the print result information including information indicating a print amount of the content printed by the printing apparatus to the management server.

4. The print management system according to claim 3, wherein the terminal device transmits the print request requesting printing of a document including the content, wherein
the management server transmits the print instruction instructing printing of the document to the print control server, wherein
the print control server transmits the print data including data of the document to the printing apparatus, and transmits, to the management server, the print result information including information indicating a print amount of the document printed by the printing apparatus, and wherein
the management server generates, based on the print result information, the billing information based on the print amount of the document and the number of a plurality of the contents included in the document.

5. The print management system according to claim 1, wherein
the print control server is configured to receive, from the printing apparatus, a print completion notification indicating that printing of the print data is completed, and
transmits the print result information to the management server when the print completion notification is received from the printing apparatus.

6. The print management system according to claim 1, wherein
the management server transmits information indicating a plurality of the contents that is configured to be designated as contents to be print and information indicating a copyright royalty set for each of the contents, and wherein
when receiving a designation of the contents to be printed, the terminal device displays information indicating the copyright royalty set for each of the contents.

7. A management server connected to a terminal device that transmits a print request requesting printing of a content and a print control server that transmits data to a printing apparatus to cause the printing apparatus to perform printing, the management server
acquires, from the print request, designation information designating a printing apparatus that prints the content,
transmits, to the print control server, a print instruction including the designation information and data of a content designated by the print request,
acquires, from the print control server, a print result by the printing apparatus designated by the designation information, and
generates, based on the print result, billing information indicating a price for a copyright of the content.

8. A print management method comprising:
a terminal device designating a content to be printed, requesting printing of the content, and transmitting a print request including designation information designating a printing apparatus that prints the content;
a management server receiving the print request, and transmitting, to a print control server, a print instruction including data of a content designated by the print request and the designation information;
the print control server receiving the print instruction, transmitting print data including data of the content to the printing apparatus designated by the designation information, acquiring a result of the print data printed by the printing apparatus, and transmitting print result information indicating the acquired result to the management server; and
the management server generating, based on the print result information, billing information indicating a price for a copyright of the content.
